(19) United States
(12) Patent Application Publication
(10) Pub. No.: US 2014/0342142 A1
(43) Pub. Date: Nov. 20, 2014

(54) GRAPHENE TRANSPARENT CONDUCTIVE FILM

(71) Applicant: ENERAGE INC., Wujie Township (TW)

(72) Inventors: Mark Y. WU, Wujie Township (TW); Cheng-Yu Hsieh, Wujie Township (TW); Cheng-Shu Peng, Wujie Township (TW)

(73) Assignee: ENERAGE INC., Wujie Township (TW)

(21) Appl. No.: 14/032,768

(22) Filed: Sep. 20, 2013

(30) Foreign Application Priority Data
May 20, 2013 (TW) 102117735

(51) Int. Cl. H01B 1/24

(52) U.S. Cl. CPC H01B 1/24
USPC 428/220

(57) ABSTRACT

A graphene transparent conductive film, Which includes a plurality of graphene sheets and a transparent conductive binder binding the graphene sheets to form the graphene transparent conductive film. The weight ratio of the graphene sheets to the transparent conductive binder is within a range of 0.01 to 1 wt %, and the volume percentage of the transparent conductive binder in the graphene transparent conductive film is within a range of 0.5 to 10%. The transparent conductive binder is a transparent conductive polymer comprising at least one structure of polythiophene and polycationic polymer. The graphene sheets are stacked and bound together by the transparent conductive binder to form the integrated conductive network structure such that the resulting graphene transparent conductive film still has lower sheet resistance with high transparency. Therefore, the present invention can be formed on the flexible support body and greatly expand the field of application.

### CROSS-REFERENCES TO RELATED APPLICATIONS

This application claims the priority of Taiwanese Patent application No. 102117735, filed on May 20, 2013, which. is incorporated herewith by reference.

### BACKGROUND OF THE INVENTION

1. Field of the Invention

The present invention generally relates to a transparent conductive film, and more specifically to a transparent conductive film formed of graphene.

2. The Prior Arts

In the prior arts, the most common transparent conductive film is primarily formed by metal-oxide film. Among traditional metal oxides, ITO (Indium Tin Oxide) is widely used because of excellent optical and electrical properties. In addition, the technology for manufacturing ITO is well developed.

U.S. Pat. No. 7,294,852 B2 disclosed a method of manufacturing ITO film, in which indium oxide and tin oxide are deposited on the substrate externally biased by sputtering. The resistance and other electrical properties of the ITO film are adjusted by the flow rate of oxygen and the deposition bias. The resistivity of the ITO film manufactured by this method is required to be less than 10-3Ω-cm,

U.S. Pat. No. 7,309,405 B2 also disclosed a method of preparing ITO film, in which ITO is deposited on the substrate to form a seed layer by sputtering, and then the ITO film is deposited on the seed layer by adjusting the processing atmosphere and conditions. The crystallinity of the whole film is determined by the seed layer during the process, and the electrical properties; like sheet resistance, is influenced by the latter deposition. This method can manufacture the ITO film with excellently smooth surface. For example, the roughness is within 10 nm. Thus, further polishing is not needed and excellent optical and electrical properties are achieved, It is very applicable to LEDs (light emitting diodes). Whatever methods as mentioned above are used, the ITO film has a problem of inflexibility. In addition, the transparency within infrared is lower.

However, ITO is costly due to rare raw material and the transparent conductive ITO film is not flexible such that its application and upcoming future are extremely limited.

Monolayer graphite, so-called graphene, has a lattice structure like a two-dimensional honeycomb, which is formed by densely packing a monolayer of carbon atoms with graphite bond (sp2). Generally, graphene is currently the thinnest and hardest material in the world. In addition, its thermal conductivity is higher than that of nanometer carbon tube and diamond. Specifically, its mobility under room temperature is higher than that of nanometer carbon tube or silicon, its electrical resistivity is much lower than that of copper or silver. Graphene is the material with the lowest resistivity in the world and graphene with a thickness of only one carbon atom can achieve excellent transparency. Therefore, graphene has great potential in various applications.

U.S. Pat. No. 7,976,950 B2 disclosed a graphene transparent conductive film formed by chemical vapor deposition. The graphene transparent conductive film. consists of graphene sheets stacked together. Specifically, the size of the graphene sheet is larger than 50 nm, and less than 9 graphene sheets are preferred for electronic devices or display panels with the best effect of stacking. Such method of preparation of the graphene film can achieve the resistivity of 10-6 Ωm and the transparency more than 80% within the range of visible light 550 nm. However, the adhesion of the graphene sheets to the transparent substrate is limited in the actual situation. Also, the conductivity is not sufficiently improved by the size of the graphene sheet and the effect of interlayer stacking.

Therefore, it is greatly desired to provide a graphene transparent conductive film to overcome the above problems of cost, process and properties in the prior arts.

### SUMMARY OF THE INVENTION

The primary objective of the present invention is to provide a graphene transparent conductive film, which comprises a plurality of graphene sheets and a transparent conductive binder binding the graphene sheets to form the graphene transparent conductive film. The weight ratio of the graphene sheets to the transparent conductive binder is within a range of 0.01 to 1 wt %, and the volume percentage of the transparent conductive binder in the graphene transparent conductive film is within a range of 0.5 to 10%.

The graphene transparent conductive film has a sheet resistance less than 500 ohm/sq and a transparency larger than 80% under visible light (with a wavelength of 300˜700 nm).

Each graphene sheet has a shape of thin sheet, a thickness of 3˜10 nm and a planar lateral dimension of 1˜5 μm. The transparent conductive binder is a transparent conductive polymer comprising at least one structure of polythiophene and polycationic polymer. More specifically, the transparent conductive binder is selected from or combined with at least one of poly(3,4-ethylenedioxythiophene) (PEDOT), poly(3,4-ethylenedioxythiophene)-polystyrene sulfonic acid (PEDOT:PSS), polyaniline and polypyrrole.

With the transparent conductive binder of the present invention, the stacked graphene sheets are adhered together to form the integrated conductive work such that the sheet resistance of the film is effective reduced. Therefore, the film still has excellent sheet resistance with high transparency and can be formed on the flexible support body, thereby greatly expanding the field of application.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic view showing a micro structure of a graphene transparent conductive film according to the present invention.

### DETAILED DESCRIPTION OF THE PREFERRED EMBODIMENT

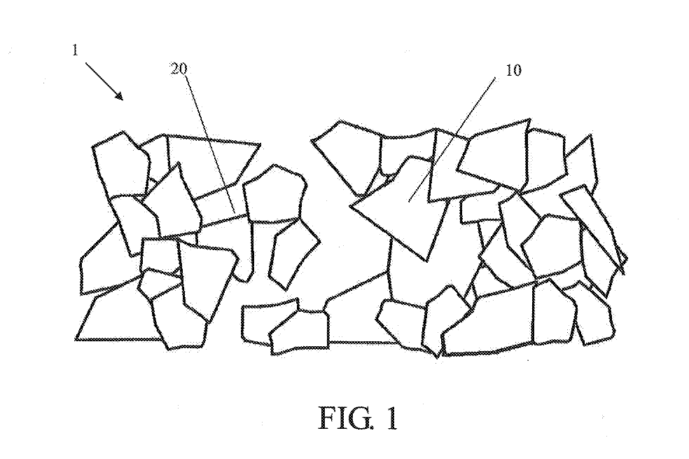

Please refer to FIG. 1. As shown in FIG. 1, the graphene transparent conductive film 1 according to the present invention comprises a plurality of graphene sheets 10 and a transparent conductive binder 20. The transparent conductive binder 20 is used to bind the graphene sheets to form the grapheme transparent conductive film 1 The graphene transparent conductive film 1 can be further attached to a support body (not shown). The weight ratio of the graphene sheets 10 to the transparent conductive binder 20 is within a range of 0.01 to 1 wt %. The volume percentage of the transparent conductive binder 20 in the graphene transparent conductive film 1 is within a range of 0.5 to 10%. The graphene transparent conductive film 1 has a thickness less than 20 nm, a sheet resistance less than 500 ohm/sq and a transparency larger than 80% under visible light (with a wavelength of 300˜700 nm). Each graphene sheet 10 is formed of a shape of thin sheet, and has a thickness of 3˜10 nm and a planar lateral dimension of 1˜5 μm. The transparent conductive binder 20 is a transparent conductive polymer, which comprises at least one structure of polythiophene and polycationic polymer. More specifically, the transparent conductive binder is selected from or combined with at least one of poly(3,4-ethylenedioxythiophene)(PEDOT), poly(3,4-ethylenedioxythiophene)-polystyrene sulfonic acid (PEDOT:PSS), polyaniline and polypyrrole.

Generally, polythiophene has a structure specified as:

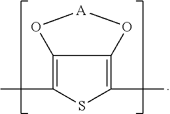

wherein A is an alkylene radical with 1˜4 carbon, or a substituted C1-C4 alkylene radical.

Specifically, polycationic polymer has a structure specified as:

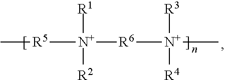

wherein the R¹, R², R³ and R⁴ are C1-C4 alkylene, R⁵ and R⁶ are saturated or unsaturated alkylene, aryl alkylene or xylylene.

In addition, the graphene sheet 10 further comprises conductive nanoparticles (not shown) attached on the surface. The conductive nanoparticles are selected from a group consists of the nano-sized gold particle, platinum particle, aluminum doped zinc oxide (AZO) particle, indium doped tin oxide (ITO) particle and combinations thereof.

In addition, the graphene transparent conductive film 1 is flexible and can be attached to flexible support body.

Hereinafter, examples of the graphene transparent conductive film of the present invention and typical process of manufacturing the same will be described in detail. To clearly explain the aspects of the present invention, in the following examples, the graphene sheets are prepared by redox reaction and heat-source-contact peeling off. First, 10 g of graphite powder is mixed with 230 ml of sulfuric acid, and then 30 g of potassium permanganate (KMnO₄) is slowly added in an ice bath to maintain 20° C. with continuously stirring up. After being dissolved, the solution is stirred for 40 min at 35° C. Next, 460 ml of deionized water is slowly added, and the solution is stirred for 20 min at 35° C. After the reaction finishes, 14 L of deionized water and 100 ml of hydrogen peroxide (H₂O₂2) are poured. After standing for 24 hours, the mixture is cleaned by 5% hydrochloric acid and then dried in vacuum to obtain the powder of graphite oxide. Subsequently, the powder of graphite oxide is in contact with the 1100° C. heat source in vacuum so as to peel off to form graphite powder material. The graphite powder material undergoes redox reaction at 1400° C. with 5% hydrogen and 95% argon so as to reduce its oxygen content to less than 1.5 wt %. The graphene sheets of the present invention with a thickness less than 10 nm and a planar lateral size larger than 1 μm are thus obtained.

Subsequently, the graphene sheets are placed in the solvent of NMP(N-Methyl pyrrolidone) to form a suspension with a concentration of 250 ppm. Specifically, its surface tension is about 40 mJ/m², and its surface voltage is about −100.4 mV. Poly(3,4-ethylenedioxythiophene)-polystyrene sulfonic acid (PEDOT:PSS) served as the transparent conductive binder is further added, and the mixture is ground for 2 hours by a planetary ball mill to form the graphene conductive slurry. The graphene conductive slurry is sprayed on the transparent substrate, and then dried to evaporate NMP so as to form the graphene transparent conductive film as desired. The sheet resistance of the graphene transparent conductive film is measured by a four point meter. The ultraviolet/visible light spectrophotometer can be used to measure the transparency of the graphene transparent conductive film, and the light with wavelength of 550 nm is served as the visible light source.

Table 1 shows the measured result of 7 illustrative experiments Ex2˜Ex7, and the primary difference is that the respective contents of PEDOT:PSS in the graphene transparent conductive films are different.

TABLE 1

| | | | | Sheet | |
|---|---|---|---|---|---|
| | conductive | Volume ratio | Transparency | resistance | Support |
| | binder | (V %) | (T %) | Rₛ (kΩ/sq) | body |
| Ex 1 | No | — | 79.82 | 2 | glass |
| Ex 2 | PEDOT:PSS | 6.1% | 78.37 | 1.10 | glass |
| Ex 3 | PEDOT:PSS | 3.1% | 78.88 | 0.20 | glass |
| Ex 4 | PEDOT:PSS | 1.6% | 90.61 | 0.21 | glass |
| Ex 5 | PEDOT:PSS | 1.6% | 91.15 | 0.23 | glass |
| Ex 6 | PEDOT:PSS | 0.72% | 90.55 | 0.23 | glass |
| Ex 7 | PEDOT:PSS | 0.72% | 92.6 | 0.13 | PET |

From the above-mentioned, one aspect of the present invention is that the transparent conductive binder is added to adhere the respective graphene sheets to form the integrated conductive network such that the sheet resistance of the film is not only effectively reduced without influence on the whole transparency, but the film also still has excellent sheet resistance with high transparency. Therefore, the graphene transparent conductive film of the present invention can be formed on the flexible substrate so as to greatly expand the field of application.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore; all such substitutions and modifications are intended to be embraced within the scope of the invention as defined in the appended claims.

What is claimed is:

1. A graphene transparent conductive film, comprising:
a plurality of graphene sheets, each having a shape of thin sheet, a thickness of 3˜10 nm and a planar lateral dimension of 1˜5 μm; and
a transparent conductive binder binding the graphene sheets,
wherein the graphene transparent conductive film has a thickness less than 20 nm, a weight ratio of the graphene sheets to the transparent conductive binder is within a range of 0.01 to 1 wt %, and a volume percentage of the transparent conductive binder in the graphene transparent conductive film is within a range of 0.5 to 10%.

2. The graphene transparent conductive film, as claimed in claim 1, wherein the graphene sheets further comprises conductive nanoparticles attached on the surface.

3. The graphene transparent conductive film as claimed in claim 2, wherein the conductive nanoparticles are selected from a group consisting of nano-sized gold particle, platinum particle, aluminum doped zinc oxide (AZO) particle, indium doped tin oxide (ITO) particle and Combinations thereof.

4. The graphene transparent conductive film as claimed in claim 1, wherein the transparent conductive binder is a transparent conductive polymer comprising at least one structure of polythiophene and polycationic polymer.

5. The graphene transparent conductive film as claimed in claim 1, wherein the transparent conductive binder comprises at least one of
poly(3,4-ethylenedioxythiophene)(PEDOT),
poly(3,4-ethylenedioxythiophene)-polystyrene sulfonic acid (PEDOT:PSS),
polyaniline and polypyrrole.

6. The graphene transparent conductive film as claimed in claim 4, wherein polythiophene has a structure specified as: 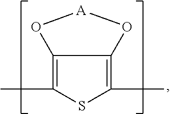
wherein A is an alkylene radical with 1˜4 carbon, or a substituted C1-C4 alkylene radical.

7. The graphene transparent conductive film as claimed in claim 4, wherein polycationic polymer has a structure specified as: 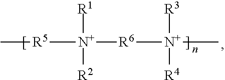
wherein the R¹, R², R³ and R⁴ are C1-C4 alkylene, R⁵ and R⁶ are saturated or unsaturated alkylene, aryl alkylene or xylylene.

8. The graphene transparent conductive film as claimed in claim 1, wherein the graphene transparent conductive film has a transparency larger than 80% under visible light.

9. The graphene transparent conductive film as claimed in claim 1, wherein the graphene transparent conductive film has a sheet resistance less than 500 ohm/sq.
